(19) United States
(12) Patent Application Publication
(10) Pub. No.: US 2023/0267459 A1
(43) Pub. Date: Aug. 24, 2023

(54) METHOD AND DEVICE FOR STAKE-BASED TOKEN MANAGEMENT ON A BLOCKCHAIN SYSTEM

(71) Applicant: SOOHO.IO INC., Seoul (KR)

(72) Inventors: Chul Ju HONG, Anyang-si, Gyeonggi-do (KR); Ji Su PARK, Seoul (KR)

(73) Assignee: SOOHO.IO INC., Seoul (KR)

(21) Appl. No.: 18/015,293

(22) PCT Filed: Nov. 13, 2020
(86) PCT No.: PCT/KR2020/015805

§ 371 Date: Jan. 9, 2023

(30) Foreign Application Priority Data
Jul. 10, 2020 (KR) 10-2020-0085640

(51) Int. Cl. G06Q 20/38

(52) U.S. Cl. CPC G06Q 20/389; G06Q 20/3825

(57) ABSTRACT

The present invention is directed to a method and device for stake-based token management on a blockchain system. The method includes: a proof-of-stake token acquisition step in which a blockchain system issues a proof-of-stake token to the user of a user system based on a stake acquisition request signal for the acquisition of a proof-of-stake token received from the user system; a distribution target token deposit step in which the blockchain system receives a distribution target token transmission signal from a token distributor system and updates the cumulative amount of distribution target tokens deposited based on the distribution target token transmission signal; and a distribution target token withdrawal step in which the blockchain system receives a distribution target token withdrawal request signal from the user system and transmits distribution target tokens to the user of the user system based on the distribution target token withdrawal request signal.

### TECHNICAL FIELD

The present invention relates to a method and device for stake-based token management on a blockchain system, and more particularly to a method and device by which distribution target tokens are distributed to a plurality of users based on their stakes on a blockchain system-based smart contract and the users can accurately determine the ratios between their stakes and the amounts of tokens owned by them.

### BACKGROUND ART

As is well known, a blockchain has the advantage of being able to block the forgery and falsification of transaction details by allowing a plurality of nodes to share and store a distributed ledger that stores the transaction details without the intervention of a central server.

Such blockchain platforms verify blocks by a consensus algorithm and provide cryptocurrency as a reward for created nodes. For example, Bitcoin is well known.

Recent block chain technology has passed the stage of exchanging values without an intermediary using a distributed ledger as in Bitcoin, and is evolving to the stage of being able to execute a decentralized application (hereinafter referred to as the “DApp”) in a distributed way by recording the results of the execution of a Turing complete programming language on a distributed ledger. This decentralized application has the characteristics of providing various services through the operation of a DApp installed on each user's computer without the intervention of a server over a peer-to-peer network directly connected between users' computers.

For example, a platform such as Ethereum is noted as a representative example. To receive services by using this platform, users needs to trade Ethereum, i.e., the base tokens of the platform, and tokens issued by each DApp, and to pay these tokens to each DApp.

Although such tokens function as currency based on a blockchain system, a method for owning and managing blockchain system-based tokens based on stakes has not yet been proposed in the prior art.

### DISCLOSURE

### Technical Problem

The present invention is intended to overcome the above-described problems, and an object of the present invention is to provide a method and device by which distribution target tokens are distributed to a plurality of users based on their stakes on a blockchain system-based smart contract and the users can accurately determine the ratios between their stakes and the amounts of tokens owned by them.

### Technical Solution

In order to accomplish the above object, the present invention provides a method for stake-based token management on a blockchain system, the method including: a proof-of-stake token acquisition step in which a blockchain system issues a proof-of-stake token to the user of a user system based on a stake acquisition request signal for the acquisition of a proof-of-stake token received from the user system; a distribution target token deposit step in which the blockchain system receives a distribution target token transmission signal for the deposit of distribution target tokens from a token distributor system and updates the cumulative amount of distribution target tokens deposited based on the distribution target token transmission signal; and a distribution target token withdrawal step in which the blockchain system receives a distribution target token withdrawal request signal from the user system and transmits distribution target tokens to the user of the user system based on the distribution target token withdrawal request signal.

In this case, the proof-of-stake token acquisition step may include: step 1 in which a token management contract of the blockchain system receives the stake acquisition request signal from the user system and checks whether a proof-of-stake token issuance condition is satisfied based on this signal; and step 2 in which, when the proof-of-stake token issuance condition is satisfied in the first step, the token management contract of the blockchain system issues a proof-of-stake token to the user of the user system; and the stake acquisition request signal includes information about an amount of a stake acquisition token and information about an amount of a proof-of-stake token to be acquired.

Furthermore, step 1 may be performed such that the token management contract of the blockchain system checks the condition of whether the amount of the stake acquisition token corresponds to the amount of the proof-of-stake token to be acquired according to an exchange ratio between the stake acquisition token and the proof-of-stake token based on the information about the amount of the stake acquisition token and the information about the amount of the proof-of-stake token included in the stake acquisition request signal.

Furthermore, step 2 may include: step 2-1 in which the token management contract of the blockchain system transmits to a stake acquisition token contract a token transfer transaction that allows a stake acquisition token corresponding to the amount of the stake acquisition token to be transmitted to itself; and step 2-2 in which the token management contract of the blockchain system changes proof-of-stake token information for the user of the user system by performing an increase of and storing information about the amount of a proof-of-stake token corresponding to the amount of the stake acquisition token transmitted to itself for the user of the user system.

Furthermore, the distribution target token deposit step may include: step 1 in which the token management contract of the blockchain system receives the distribution target token transmission signal from a token distributor system; step 2 in which the token management contract of the blockchain system transmits to the stake target token contract a token transfer transaction that allows stake target tokens corresponding to the amount of stake target tokens to be transmitted to itself; and step 3 in which the token management contract of the blockchain system updates information about the amount of distribution target tokens deposited so far, which is the cumulative amount of distribution target tokens deposited; and the distribution target token transmission signal includes information about the amount of distribution target tokens.

Furthermore, the distribution target token withdrawal step may include: step 1 in which the token management contract of the blockchain system receives the distribution target token withdrawal request signal from the user system, and calculates the amount of distribution of distribution target tokens for the user of the user system based on this signal; and step 2 in which the token management contract of the blockchain system transmits an amount of distribution target tokens corresponding to the calculated amount of distribution to the user of the user system.

Furthermore, it is preferable that step 1 be performed such that the token management contract of the blockchain system calculates the amount of distribution by the formula “(the cumulative amount of distribution target tokens deposited so far−the cumulative amount of distribution target tokens deposited when the user withdrew distribution target tokens last)×a stake,” where the stake is “the amount of the proof-of-stake token owned by the user/the total amount of proof-of-stake tokens issued.”

Furthermore, the method may further include, after step 1, a step in which the token management contract of the blockchain system performs compensation completion processing that updates “the cumulative amount of distribution target tokens deposited when the user withdrew distribution target tokens last” with “the cumulative amount of distribution target tokens deposited until the specific user transmits the distribution target token withdrawal request signal.”

Furthermore, step 2 may include a step in which the token management contract of the blockchain system transmits to a distribution target token contract a token transfer transaction that allows distribution target tokens corresponding to the amount of distribution to be transmitted to the user of the user system.

Furthermore, the method may include: a step in which, when receiving a stake liquidation request signal from the user system, the token management contract of the blockchain system calculates an amount of return of a stake acquisition token for the corresponding user based on this signal; a step in which the token management contract of the blockchain system changes proof-of-stake token information according to the calculated amount of return; and a step in which the token management contract of the blockchain system transmits to a stake acquisition token contract a stake acquisition token transfer transaction that allows a stake acquisition token corresponding to the calculated amount of return to be transmitted to the user of the user system.

Furthermore, the method may include: step 1 in which the token management contract of the blockchain system receives a stake transfer request signal including information about the amount of transfer and information about a transferee from the user system and calculates the amount of distribution of distribution target tokens for the user of the user system based on this signal; step 2 in which the token management contract of the blockchain system transmits an amount of distribution target tokens corresponding to the calculated amount of distribution to the user of the user system; and step 3 in which the token management contract of the blockchain system changes proof-of-stake token information by subtracting information about the amount of a proof-of-stake token corresponding to the information about the amount of transfer for the user of the user system and performing an increase of and storing information about the amount of a proof-of-stake token corresponding to the information about the amount of transfer for the transferee.

Moreover, when the total amount of proof-of-stake tokens issued is changed, step 1 may be performed such that the token management contract of the blockchain system calculates the amount of distribution by the formula “(current A−A when the user withdrew distribution target tokens last)×the amount of the proof-of-stake token currently owned,” where A is “the cumulative amount of distribution target tokens deposited so far/a total amount of proof-of-stake tokens issued at the time when the distribution target tokens are deposited.”

According to another aspect of the present invention, there is provided a device for stake-based token management on a blockchain system, the device being included in each of one or more nodes constituting the blockchain system and managing tokens based on stakes, the device including: a proof-of-stake token acquisition management unit configured to issue a proof-of-stake token to the user of a user system based on a stake acquisition request signal for the acquisition of a proof-of-stake token received from the user system; a distribution target token deposit management unit configured to receive a distribution target token transmission signal for the deposit of distribution target tokens from a token distributor system and updates the cumulative amount of distribution target tokens deposited based on the distribution target token transmission signal; and a distribution target token withdrawal management unit configured to receive a distribution target token withdrawal request signal from the user system and transmits distribution target tokens to the user of the user system based on the received distribution target token withdrawal request signal.

### Advantageous Effects

According to the present invention, there are provide the method and device by which distribution target tokens are distributed to a plurality of users based on their stakes on the blockchain system-based smart contract and the users can accurately determine the ratios between their stakes and the amounts of tokens owned by them.

In addition, according to the present invention, effects may be provided in that distribution target tokens are associated with tangible/intangible assets, and multiple users are allowed to jointly own the distribution target tokens and to receive distributed profits based on their stakes.

### DESCRIPTION OF DRAWINGS

FIGS. 1 to 3 show the configuration of an overall system in which the embodiments according to the present invention are performed;

FIG. 4 is a flowchart showing a method for stake-based token management on a blockchain system according to an embodiment of the present invention;

FIG. 5 is a flowchart showing a proof-of-stake token acquisition step (S100) in the method for stake-based token management according to the embodiment of FIG. 4;

FIG. 6 is a flowchart showing a distribution target token deposit step (S200) in the method for stake-based token management according to the embodiment of FIG. 4;

FIG. 7 is a flowchart illustrating a distribution target token withdrawal step (S300) in the method for stake-based token management according to the embodiment of FIG. 4;

FIG. 8 is a diagram showing data managed by a token management contract (110);

FIG. 9 is a flowchart showing the process of liquidating a proof-of-stake token;

FIG. 10 is a flowchart showing the process of transferring a proof-of-stake token; and

FIG. 11 is a diagram showing a device (130) for stake-based token management for performing a method for stake-based token management according to the present invention.

### BEST MODE

Embodiments according to the present invention will be described in detail below with reference to the accompanying drawings.

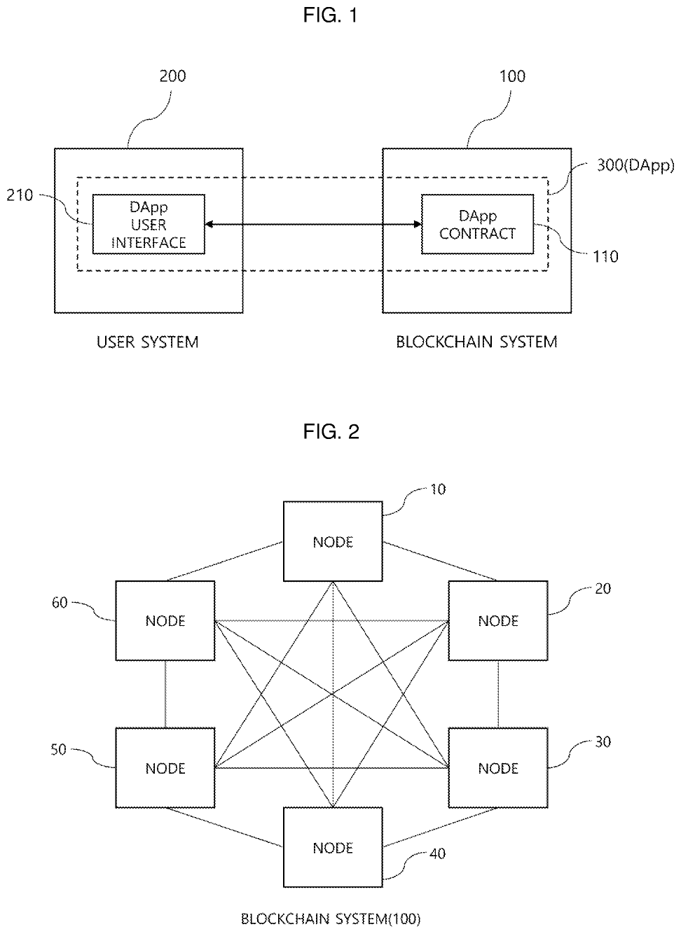

FIGS. 1 to 3 show the configuration of an overall system in which the embodiments according to the present invention are performed.

Referring to FIG. 1, a blockchain system 100 and a user system 200 are connected to each other over a network.

The user system 200 refers to a device such as a conventionally known computer, or smartphone, or the like. The blockchain system 100 refers to a network constructed by a plurality of distributed nodes 10 to 60 (see FIG. 2) that are directly connected to each other via a peer-to-peer (P2P) communication protocol.

FIG. 2 is a diagram showing an example of the blockchain system 100.

As shown in FIG. 2, the blockchain system 100 is constructed by the plurality of distributed nodes 10 to 60, and the plurality of nodes 10 to 60 construct a network in which the plurality of nodes 10 to 60 are directly connected to each other by a P2P communication protocol.

In this case, the plurality of nodes 10 to 60 may be physically devices such as computers and/or smartphones, and update state variables corresponding to the results of the execution of a mutually shared ledger or smart contract by a preset consensus algorithm in the blockchain system 100.

As an embodiment, each of the nodes 10 to 60 may store new transactions or state variables in the above-described ledger in a set of blocks (a blockchain) having a structure in which one or more blocks are successively connected to each other like a chain, and a virtual machine for executing a smart contract may be provided.

A method for the implementation of a blockchain in conventional technologies such as Bitcoin and Ethereum will be described in more detail. Each of the blocks constituting a blockchain stores transaction information, which is information about transaction details between users, through the blockchain system 100, and may be composed of a block header and a transaction, which are generated through proof-of-work by so-called miner nodes and included in the blockchain.

Since the blocks, the blockchain, and the blockchain system 100 themselves are known in the prior art and are not direct targets of the present invention, detailed descriptions thereof are omitted here.

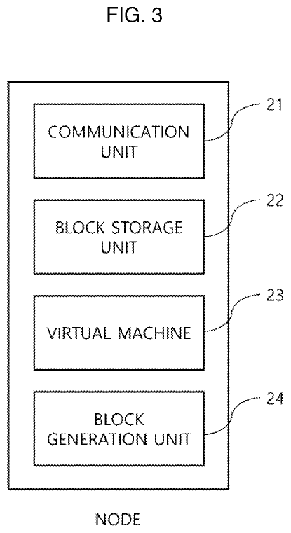

FIG. 3 is a diagram showing an example of the configuration of each of the nodes constituting the blockchain system 100.

Referring to FIG. 3, each of the nodes 10 to 60 includes a communication unit 21, a block storage unit 22, a virtual machine 23, and a block generation unit 24.

The communication unit 21 is a means for performing a communication function with other nodes 10 to 60 of the blockchain system 100 and the user system 200. As described above, the block storage unit 22 is responsible for storing a block constituting part of the blockchain.

The virtual machine 23 is a means for executing a smart contract, and the block generation unit 24 is a means for generating a new block.

Since the configuration of these nodes 10 to 60 is also known in the prior art and is not a direct target of the present invention, a detailed description thereof is omitted here.

Referring back to FIG. 1, the user of the user system 200 uses a service that is provided by a decentralized application (DApp) 300 while operating in conjunction with the blockchain system 100.

In this case, the DApp (decentralized application) 300 (hereinafter referred to as the “DApp 300”) refers to an application that can provide a specific service based on the blockchain system 100 without the intervention of a centralized server based on the blockchain system 100, i.e., the plurality of distributed nodes 10 to 60 (see FIG. 2) constituting the blockchain system 100.

For example, the DApp 300 may be an application that provides a service, such as a financial transaction service, a game service, a file sharing service, or a storage service, based on the blockchain system 100.

The DApp 300 is known through the Ethereum blockchain platform, and is an application that stores a “smart contract” composed of code by programming, allows the smart contract to be executed on the nodes 10 to 60 constituting the blockchain system 100, and also allows transaction details, obtained by the results of the execution of the smart contract, to be reflected into the blocks.

As shown in FIG. 1, the DApp 300 includes a DApp user interface 210, and a DApp contract 110, which is a smart contract corresponding to the DApp.

The DApp user interface 210 is an interface via which a user receives a service provided by the DApp 300 through communication with the DApp contract 110 of the blockchain system 100 via the user system 200, and may be a client program such as a browser, an electronic wallet, or the like.

The DApp contract 110 is a smart contract corresponding to the DApp 300, and is stored in the blockchain system 100, as shown in FIG. 1. The DApp contract 110 is a smart contract for providing a service provided by the DApp 300, and is stored in the blocks of the nodes 10 to 60 when the DApp 300 is distributed to the blockchain system 100.

A user uses the service provided by the DApp 300 by transmitting a transaction for the performance of a specific service to the DApp contract 110 through the DApp user interface 210 of the user system 200 and receiving the results of the transaction. Since the detailed configurations and operations of the DApp 300 and the DApp contract 110 are well known in the conventional blockchain systems such as Ethereum and are not direct targets of the present invention, detailed descriptions thereof are omitted.

Meanwhile, in order to use the service provided by the DApp 300 based on the blockchain system 100, a token, which is the cryptocurrency used in the DApp 300, has to be used, as described in the background art section. For example, in a blockchain platform such as Ethereum, it may be possible to distribute the DApp 300 to the blockchain system while issuing a token, and a user purchases a token for the use of the DApp 300 and uses the DApp 300.

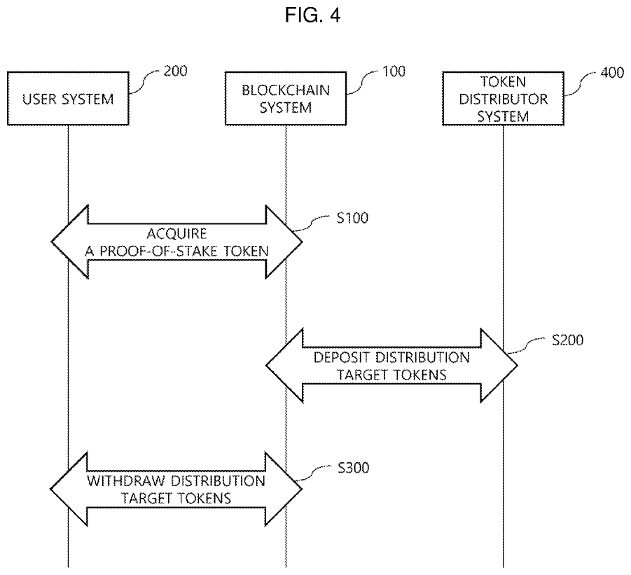

Based on the above basic information of the blockchain, embodiments according to the present invention will be described with reference to FIG. 4 and its following drawings.

FIG. 4 is a flowchart showing a method for stake-based token management on a blockchain system according to an embodiment of the present invention.

As shown in FIG. 4, the method for stake-based token management on a blockchain system according to the present embodiment (hereinafter simply referred to as the “method for stake-based token management”) includes a proof-of-stake token acquisition step S100, a distribution target token deposit step S200, and a distribution target token withdrawal step S300.

The proof-of-stake token acquisition step S100 refers to a step in which the blockchain system 100 issues a proof-of-stake token to the user of the user system 200 based on a stake acquisition request signal for the acquisition of a proof-of-stake token received from the user system 200.

The distribution target token deposit step S200 is a step in which the blockchain system 100 receives a distribution target token transmission signal for the deposit of a distribution target token from a token distributor system 400 and updates the cumulative amount of distribution target tokens deposited based on the distribution target token transmission signal.

The distribution target token withdrawal step S300 is a step in which the blockchain system 100 receives a distribution target token withdrawal request signal from the user system 200 and transmits distribution target tokens to the user of the user system 200 based on the received distribution target withdrawal request signal.

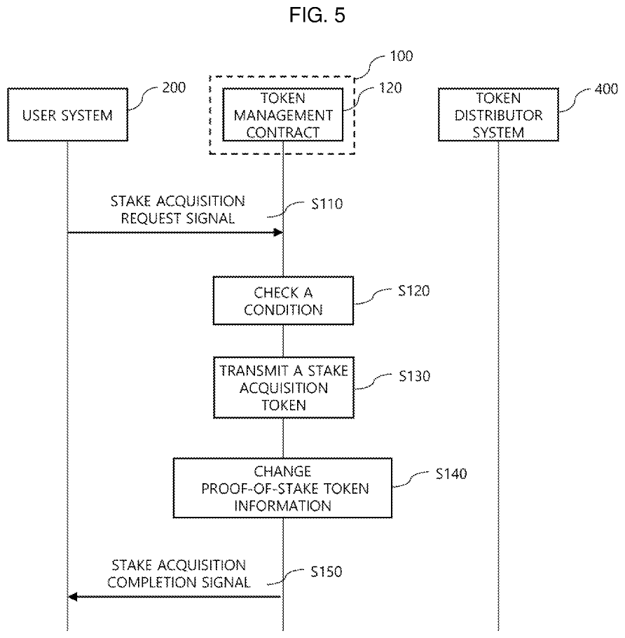

Each of the above-described steps will be described in detail below with reference to FIG. 5 and its following drawings.

FIG. 5 is a flowchart showing the proof-of-stake token acquisition step S100 in the method for stake-based token management according to the embodiment of FIG. 4.

Referring to FIG. 5, first, a user transmits a stake acquisition request signal for the acquisition of a proof-of-stake token to the token management contract 120 of the blockchain system 100 through the user system 200 in step S110.

In this case, the proof-of-stake token refers to a token that is a criterion for determining a stake for distribution target tokens.

Furthermore, as will be described later, the distribution target tokens are tokens that can be owned and managed based on a stake, and the stake owned by a specific user for the distribution target tokens is determined by the amount of the proof-of-stake token owned by the corresponding user.

Furthermore, the stake acquisition request signal is a signal requesting that the token management contract 120, which is a smart contract implemented in the blockchain system 100, issue a proof-of-stake token to the user of the user system 200, and includes information about the amount of the stake acquisition token and information about the amount of the proof-of-stake token to be acquired.

The stake acquisition request signal is transmitted in the form of a transaction that enables the token management contract 120 of the blockchain system 100 to perform the above-described operation, and may include other information necessary for the transaction, such as a recipient's address, a sender's address, and a transaction execution cost. However, since this is exemplary, may vary depending on the blockchain system 100 and is not a direct target of the present invention, a detailed description thereof will be omitted.

In this case, the stake acquisition token refers to a token that is transmitted by a user to the token management contract 120 in order to acquire a proof-of-stake token.

The token management contract 120 of the blockchain system 100 checks whether a proof-of-stake token issuance condition is satisfied according to the exchange ratio between the stake acquisition token and the proof-of-stake token based on the information about the amount of the stake acquisition token and the information about the amount of the proof-of-stake token included in the stake acquisition request signal in step S120.

In this case, the token management contract 120 may be implemented in the form of a smart contract, which is an application that is distributed to the nodes constituting the blockchain system 100 and executed in each of the nodes, as described above.

The exchange ratio between the stake acquisition token and the proof-of-stake token is stored in the token management contract 120 in advance. The token management contract 120 checks the condition of whether the amount of the stake acquisition token corresponds to the amount of the proof-of-stake token to be acquired according to the stored exchange ratio, and transmits a stake acquisition token corresponding to the amount of the stake acquisition token to itself when the condition is satisfied in step S130.

This means transmitting a token transfer transaction, in which the recipient of the stake acquisition token corresponding to the corresponding amount of the token is set to itself, i.e., the token management contract 120, to a stake acquisition token contract (not shown) that manages stake acquisition tokens. This transaction includes information such as a sender's address, a recipient's address, and the amount of transmission. The sender is the user of the user system 100, the recipient is the token management contract 120, and the amount of transmission refers to the amount of the stake acquisition token corresponding to the amount of the proof-of-stake token to be acquired.

The stake acquisition token contract (not shown) performs a smart contract that adds a stake acquisition token corresponding to the amount of transmission for the recipient, i.e., the token management contract 120, and performs a reduction of the corresponding amount for the sender, i.e., the user of the user system 100, based on the received transaction, and transmits the results of the performance to the token management contract 120.

Since these transaction and performance processes are also common processes when tokens are transmitted in the blockchain system 100 and are not direct targets of the present invention, detailed descriptions thereof are omitted.

When the token management contract 120 receives the results of the performance from the stake acquisition token contract (not shown), the token management contract 120 changes information about a proof-of-stake token for the user by performing an increase of and storing information about the amount of the proof-of-stake token corresponding to the information about the amount of the stake acquisition token transmitted to itself for the user of the user system 100 in step S140. This means that the proof-of-stake token has been issued for the corresponding user.

When the change of the information about a proof-of-stake token is completed, the token management contract 120 transmits a stake acquisition completion signal indicating that the proof-of-stake token acquisition has been completed to the user system 100 in step S150.

Meanwhile, in step S120, when the amount of the stake acquisition token does not correspond to the amount of the proof-of-stake token to be acquired according to the stored exchange ratio, the transaction of step S110 is rolled back.

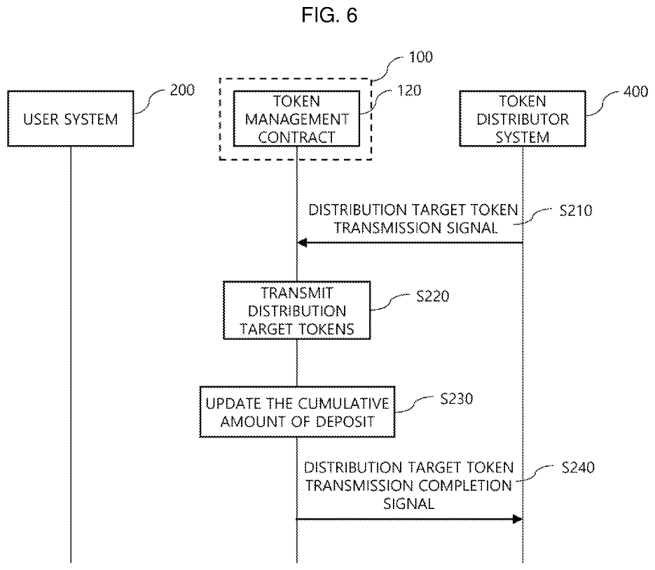

FIG. 6 is a flowchart showing the distribution target token deposit step S200 in the method for stake-based token management according to the embodiment of FIG. 4.

Referring to FIG. 6, a token distributor transmits a distribution target token transmission signal to the token management contract 120 of the blockchain system 100 through the token distributor system 400 in step S210.

In this case, the distribution target token transmission signal refers to a transaction for the transmission of distribution target tokens to the token management contract 120 of the blockchain system 100, and includes information about the amount of distribution target tokens.

In this case, the distribution target tokens are tokens that can be owned and managed based on a stake, as described above, and the stake is determined by the amount of the proof-of-stake token acquired by the user in the proof-of-stake token acquisition step S100.

The distribution target token transmission signal is also transmitted in the form of a transaction that enables the token management contract 120 of the blockchain system 100 to perform the above-described operation.

The token management contract 120 of the blockchain system 100 transmits the amount of distribution target tokens, included in the distribution target token transmission signal, to itself in step S220.

This means transmitting a token transfer transaction, in which the recipient of distribution target tokens corresponding to the corresponding amount of tokens is set to itself, i.e., the token management contract 120, to a distribution target token contract (not shown) that manages distribution target tokens. In this transaction, the sender is the token distributor of the token distributor system 400, the recipient is the token management contract 120, and the amount of transmission is the amount of distribution target tokens transmitted from the token distributor system 400.

The distribution target token contract (not shown) performs a smart contract that adds distribution target tokens corresponding to the amount of transmission for the recipient, i.e., the token management contract 120, and performs a reduction of the corresponding amount for the sender, i.e., the token distributer, based on the received transaction, and transmits the results of the performance to the token management contract 120.

When the token management contract 120 receives the results of the performance from the distribution target contract (not shown), the token management contract 120 updates the cumulative amount of distribution target tokens deposited, i.e., information about the amount of distribution target tokens deposited so far, in step S230.

When the information about the amount of distribution target tokens is updated, the token management contract 120 transmits a distribution target token transmission completion signal indicating that the transmission of the distribution target tokens has been completed to the token distributor system 400 in step S240.

In this state, the token management contract 120 becomes able to allow distribution target tokens to be withdrawn by each user according to a distribution ratio determined by the amount of the proof-of-stake token issued for the user through the previous proof-of-stake token acquisition step S100.

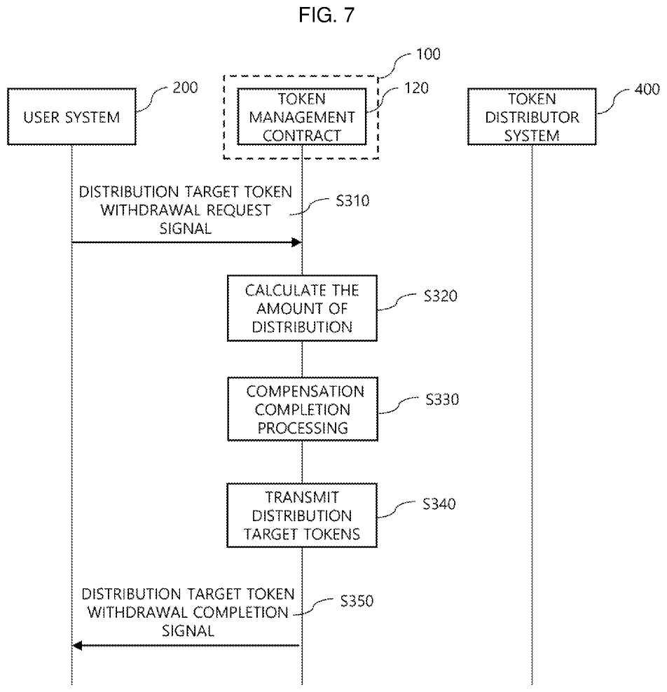

FIG. 7 is a flowchart illustrating the distribution target token withdrawal step S300 in the method for stake-based token management according to the embodiment of FIG. 4.

First, a user who desires to withdraw distribution target tokens transmits a distribution target token withdrawal request signal to the token management contract 120 of the blockchain system 100 through the user system 200 in step S310.

The distribution target token withdrawal request signal is a transaction that allows the token management contract 120 of the blockchain system 100 to transmit distribution target tokens to the corresponding user based on the amount of the proof-of-stake token owned by the user of the user system 200 that has transmitted the corresponding signal.

Due to the natures of the blockchain system 100 and the smart contract, it is not easy to implement the transmission of distribution target tokens for only a part of a user's stake, so that it is desirable that the distribution target token withdrawal step S300 be configured to transmit distribution target tokens corresponding to all the user's stake. Accordingly, the distribution target token withdrawal request signal does not necessarily include information about the amount of withdrawal.

The token management contract 120 having received the distribution target token withdrawal request signal checks the amount of the proof-of-stake token stored for the user of the user system 200 that has transmitted the distribution target token withdrawal request signal and then calculates the amount of distribution of distribution target tokens based on the results of the checking in step S320.

Since the token management contract 120 stores information about the amount of the proof-of-stake token issued for a specific user as described above, the stake of the user who has transmitted the distribution target token withdrawal request signal may be determined based on “the amount of the proof-of-stake token owned by the user/the total amount of proof-of-stake tokens issued.”

In addition, the token management contract 120 calculates the amount of distribution by the formula “(the cumulative amount of distribution target tokens accumulated so far−the cumulative amount of distribution target tokens deposited when the user withdraws distribution target tokens last)×the stake.”

The reason for this is that due to the nature of the smart contract of the blockchain system 100, variables stored in the smart contract may be changed only when an interaction occurs, so that, when there occurs an interaction in which a specific user transmits a distribution target token withdrawal request signal, distribution target tokens corresponding to the stakes may not be distributed to all proof-of-stake token owners at one time and only a contract variable for the amount of distribution target tokens deposited may be changed.

Therefore, when the specific user transmits a distribution target token withdrawal request signal as described above, the token management contract 120 calculates the amount of distribution by multiplying the stake by the amount of distribution target tokens obtained by excluding the cumulative amount of distribution target tokens deposited when the corresponding user withdrew distribution target tokens last, i.e., immediately before, from the cumulative amount of distribution target tokens deposited up to that point in time.

When the amount of distribution is calculated, the token management contract 120 performs compensation completion processing that updates the “the cumulative amount of distribution target tokens deposited when the corresponding user withdrew distribution target tokens last” with the “cumulative amount of distribution target tokens deposited until the specific user transmits the distribution target withdrawal request signal” in step S330.

In addition, the token management contract 120 transmits to the user of the user system 100 an amount of distribution target tokens corresponding to the amount of distribution calculated above in step S340.

This means that the token management contract 120 of the blockchain system 100 transmits a token transfer transaction, in which a recipient who will receive distribution target tokens corresponding to the corresponding amount of tokens is set to the user of the user system 200, to the distribution target token contract (not shown) that manages distribution target tokens.

In this transaction, the sender is the token management contract 120, the recipient is the user of the user system 200 that has transmitted the distribution target token withdrawal request signal, and the amount of transmission refers to the amount of distribution target tokens corresponding to the amount of distribution calculated above.

The distribution target token contract (not shown) performs a smart contract that adds distribution target tokens corresponding to the amount of transmission for the recipient, i.e., the user, and performs a reduction of the corresponding amount for the sender, i.e., the token management contract 120, based on the received transaction, and transmits the results of the performance to the token management contract 120.

When receiving the results of the performance from the distribution target contract (not shown), the token management contract 120 transmits a distribution target token withdrawal completion signal indicating that the distribution target tokens have been withdrawn, i.e., the distribution target tokens have been transmitted, to the user system 200 in step S350.

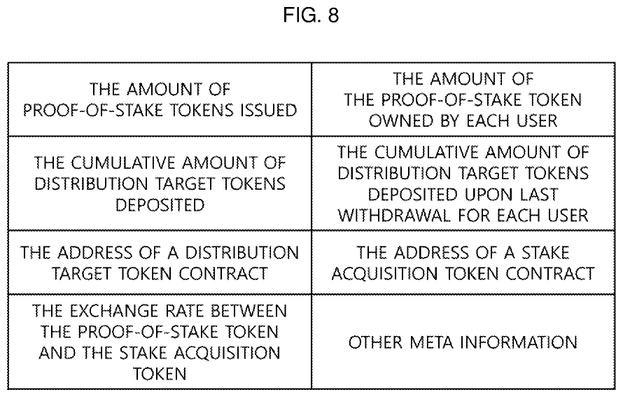

FIG. 8 is a diagram showing data managed by the token management contract 120.

Referring to FIG. 8, the token management contract 120 manages the amount of proof-of-stake tokens issued, the amount of the proof-of-stake token owned by each user, the cumulative amount of distribution target tokens deposited, the cumulative amount of distribution target tokens deposited upon last withdrawal for each user, the address of a distribution target token contract, the address of a stake acquisition token contract, the exchange rate between a proof-of-stake token and a stake acquisition token, and other meta information.

Although these types of data are data used in the processes described above with reference to FIGS. 4 to 7, this description is exemplary. It is obvious that some of these types of data may not be used or additional information may be included as needed.

Meanwhile, in the embodiments described with reference to FIGS. 4 to 8, it is desirable that an issuance end point (a distribution deadline) for a proof-of-stake token be set in advance and a proof-of-stake token be no longer issued when the distribution deadline has passed or a total amount of issuance has been completed.

In addition, it is desirable to perform a liquidation process in which, when the distribution deadline has passed but a total amount of proof-of-stake tokens has not been issued, the token management contract 120 receives and wipes out previously issued proof-of-stake tokens and returns the stake acquisition token transmitted to each user by retransmitting the stake acquisition token.

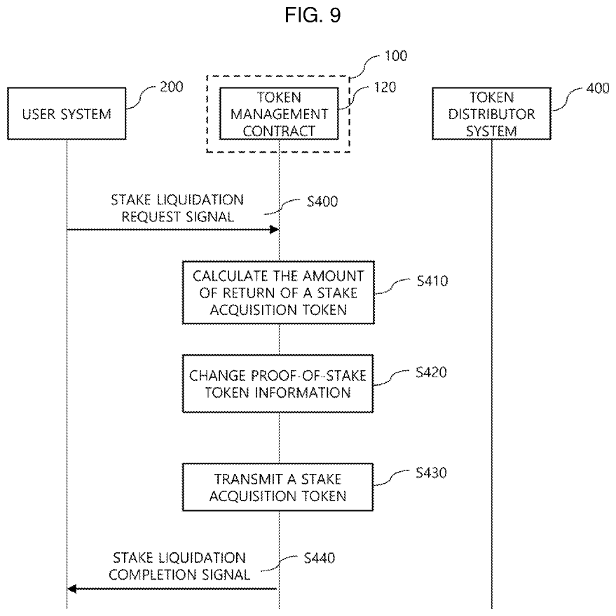

FIG. 9 is a flowchart showing the process of liquidating a proof-of-stake token.

Referring to FIG. 9, a user transmits a stake liquidation request signal to the token management contract 120 of the blockchain system 100 through the user system 200 in step S400.

The stake liquidation request signal is a signal requesting the token management contract 120 of the blockchain system 100 to liquidate a proof-of-stake token issued to the user of the user system 200, and is also a transaction.

The token management contract 120 of the blockchain system 100 having received the stake liquidation request signal calculates the amount of return of the stake acquisition token for the corresponding user in step S410.

This may be calculated based on the amount of the proof-of-stake token owned by each user and stored in the token management contract 120 and the exchange ratio between the proof-of-stake token and the stake acquisition token.

When the amount of return of the stake acquisition token is calculated, the token management contract 120 changes proof-of-stake token information in step S420.

This means changing the amount of the proof-of-stake token owned by the user to “0” and adding information indicating that the stake has been liquidated to the token management contract 120.

When the proof-of-stake token information is changed, the token management contract 120 transmits a stake acquisition token corresponding to the calculated amount of return of the stake acquisition token to the user of the user system 200 in step S430.

This means transmitting a stake acquisition token transfer transaction, in which the recipient who will receive a token corresponding to the corresponding amount of the token is set to the user who has transmitted the stake liquidation request signal, to the stake acquisition token contract (not shown) that manages stake acquisition tokens.

In this transfer transaction, the sender is the token management contract 120, the recipient is the user who has transmitted the stake liquidation request signal, and the amount of transmission is the amount of the state acquisition token corresponding to the calculated amount of return of the state acquisition token.

The stake acquisition token contract (not shown) performs a smart contract that adds the amount of the stake acquisition token corresponding to the amount of transmission for the recipient, i.e., the user, and performs a reduction of the corresponding amount for the sender, i.e., the token management contract 120, based on the received transaction, and transmits the results of the performance to the token management contract 120.

When receiving the results of the performance from the stake acquisition token contract (not shown), the token management contract 120 transmits a stake liquidation completion signal indicating that stake liquidation has been completed to the user system 200 in step S440.

Meanwhile, in the present invention, the user who has been issued the proof-of-stake token may transfer it to another user.

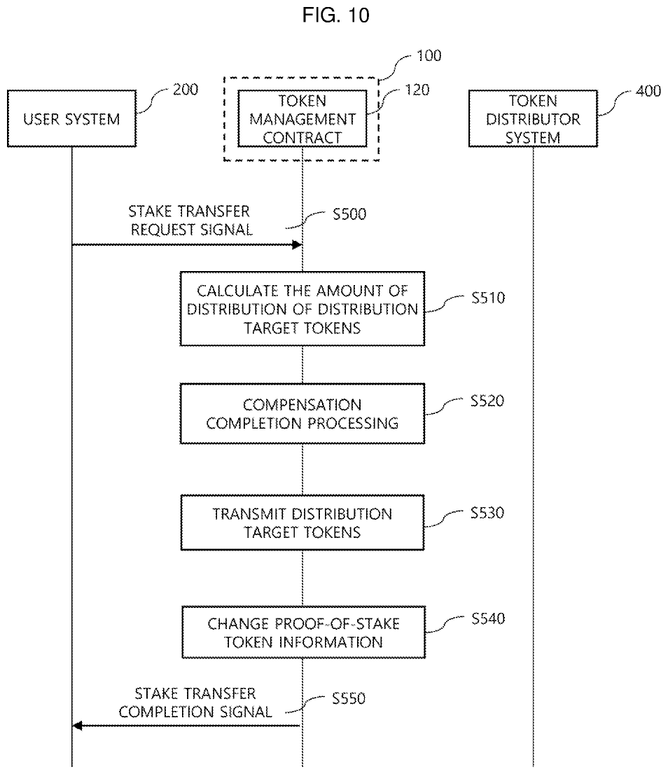

FIG. 10 is a flowchart showing the process of transferring a proof-of-stake token.

Referring to FIG. 10, a user transmits a stake transfer request signal to the token management contract 120 of the blockchain system 100 through the user system 200 in step S500.

The stake transfer request signal is a transaction requesting that the token management contract 120 of the blockchain system 100 transfer a proof-of-stake token, issued to the user (a transferor) of the user system 200, to another user (a transferee).

In this case, the stake transfer request signal includes information about the address of the transferor, information about the address of the transferee, and information about the amount of transfer.

In this case, the information about the amount of transfer refers to the amount of the proof-of-stake token to be transferred to the transferee out of the proof-of-stake token owned by the transferor, i.e., the user of the user system 200 who has transmitted the stake transfer request signal. The information about the amount of transfer may be all or part of the proof-of-stake token owned.

The token management contract 120 having received the stake transfer request signal checks the amount of the proof-of-stake token stored for the user of the user system 200 that has transmitted the stake transfer request signal, calculates the amount of distribution of distribution target tokens based on the results of the checking in step S510, and then performs compensation completion processing.

In this case, when information about the amount of transfer included in the stake transfer request signal is not all, the amount of distribution of distribution target tokens is calculated based on the information about the amount of transfer.

Furthermore, since the process of calculating the amount of distribution and the process of performing compensation completion processing are the same as those described in steps S320 and S330 of FIG. 7, detailed descriptions thereof will be omitted.

Next, the token management contract 120 transmits to the user of the user system 100 an amount of distribution target tokens corresponding to the calculated amount of distribution in step S530. Since this is the same as that of step S340 in FIG. 7 above, a detailed description thereof will be omitted.

When the transmission of distribution target tokens is completed, the token management contract 120 changes proof-of-stake token information in step S540.

This means that the token management contract 120 subtracts the amount of transfer from information about the amount of the proof-of-stake token of the transferor, i.e., information about the amount of tokens owned by the user of the user system 100, and adds and stores information about an amount of tokens equal to the amount of transfer for the transferee.

When the change of the proof-of-stake token information is completed, the token management contract 120 transmits a stake transfer completion signal indicating that a stake transfer procedure has been completed to the user system 100 in step S550.

Meanwhile, it is desirable that a setting be made such that the distribution target token deposit step S200 and the distribution target token withdrawal step S300 in the embodiment described with reference to FIGS. 4 to 8 are not performed until an amount of proof-of-stake tokens corresponding to the total amount of proof-of-stake tokens issued are issued. This may be implemented using a variable for the total amount of issuance stored and managed in the token management contract 120.

In this case, there may be used a method of using a time limit corresponding to the time until the total amount of issuance is completely issued. This may be implemented, for example, by referring to a block number stored in a block of the blockchain system 100, a block timestamp, a variable value of a specific smart contract, and/or the like.

In this case, it is desirable that when an amount of proof-of-stake tokens corresponding to the total amount of issuance are not issued before the expiration of the time limit, the stake liquidation process described above be performed.

Alternatively, all the proof-of-stake tokens may be treated as having been issued by a method of changing the amount of issuance of proof-of-stake tokens, provided at the time when the time limit is reached, to the total amount of issuance.

In particular, in the case of changing the total amount of issuance of proof-of-stake tokens after the proof-of-stake token acquisition step S100 has been normally performed, the following method may be used.

First, there may be added an interaction in which, when the total amount of issuance of proof-of-stake tokens increases, the administrator of the token management contract 120 may modify the value of the total amount of issuance using the administrator's authority and transmit it to users.

Meanwhile, there may be added an interaction in which, when the total amount of issuance of proof-of-stake tokens is reduced, a proof-of-stake token is transferred to the token management contract 120 and a stake acquisition token is transmitted to the user accordingly.

Meanwhile, when the total amount of issuance of proof-of-stake tokens is changed as described above, the following processing is required in the distribution amount calculation step S320 described in FIG. 7.

First, “the cumulative amount of distribution target tokens deposited so far” is modified to “the cumulative amount of distribution target tokens deposited so far/the total amount of proof-of-stake tokens issued at the time when the distribution target tokens are deposited,” and this is set as A. In this case, when the amount of distribution is calculated, the amount of distribution is calculated by the formula “(current A−A when the user withdrew distribution target tokens last)×the amount of the proof-of-stake token currently owned,” instead of the formula “(the cumulative amount of distribution target tokens deposited so far−the cumulative amount of distribution target tokens deposited when the user withdrew distribution target tokens last)×the stake.”

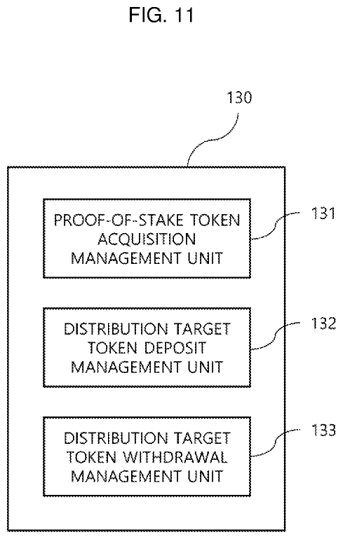

FIG. 11 is a diagram showing a device 130 for stake-based token management for performing the method for stake-based token management according to the present invention.

In FIG. 11, the device 130 for stake-based token management is a device that is included in each of one or more nodes constituting the blockchain system 100 and is intended to perform the above-described method for stake-based token management. The device 130 for stake-based token management may be implemented in the form of the management contract 120 described above.

The token management contract 120, i.e., the device 130 for stake-based token management, is a smart contract that is executed on the blockchain system 100 as described above, and is included in each of the nodes constituting the blockchain system 100. The token management contract 120, i.e., the device 130 for stake-based token management, performs its operation according to the present invention in such a manner as to be executed in each of the nodes, store results in a block, and share the results with other nodes.

The device 130 for stake-based token management includes a proof-of-stake token acquisition management unit 131, a distribution target token deposit management unit 132, and a distribution target token withdrawal management unit 133.

The proof-of-stake token acquisition management unit 131 performs the function of issuing a proof-of-stake token to the user of the user system 200 based on a stake acquisition request signal for the acquisition of a proof-of-stake token received from the user system 200. This corresponds to the operation of the proof-of-stake token acquisition step S100 in FIG. 4 described above.

Furthermore, the distribution target token deposit management unit 132 performs the function of receiving a distribution target token transmission signal for the deposit of distribution target tokens from the token distributor system 400 and updating the cumulative amount of distribution target tokens deposited based on the distribution target token transmission signal. This corresponds to the distribution target token deposit step S200 in FIG. 4 described above.

Moreover, the distribution target token withdrawal management unit 133 performs the function of receiving a distribution target token withdrawal request signal from the user system 100 and transmitting distribution target tokens to the user of the user system 100 based on the received distribution target token withdrawal request signal. This corresponds to the distribution target token withdrawal step S300 in FIG. 4 described above.

Since the specific operations of the proof-of-stake token acquisition management unit 131, the distribution target token deposit management unit 132, and the distribution target token withdrawal management unit 133 are the same as those described above with reference to FIGS. 4 to 10, detailed descriptions thereof will be omitted.

Although the present invention has been described above with reference to the preferred embodiments of the present invention, the present invention is not limited to the above-described embodiments, and various modifications and alterations may be possible within the scope of the present invention.

1. A method for stake-based token management on a blockchain system, the method comprising:
a proof-of-stake token acquisition step in which a blockchain system issues a proof-of-stake token to a user of a user system based on a stake acquisition request signal for acquisition of a proof-of-stake token received from the user system;
a distribution target token deposit step in which the blockchain system receives a distribution target token transmission signal for deposit of distribution target tokens from a token distributor system and updates a cumulative amount of distribution target tokens deposited based on the distribution target token transmission signal; and
a distribution target token withdrawal step in which the blockchain system receives a distribution target token withdrawal request signal from the user system and transmits distribution target tokens to the user of the user system based on the distribution target token withdrawal request signal.

2. The method of claim 1, wherein:
the proof-of-stake token acquisition step comprises:
step 1 in which a token management contract of the blockchain system receives the stake acquisition request signal from the user system and checks whether a proof-of-stake token issuance condition is satisfied based on this signal; and
step 2 in which, when the proof-of-stake token issuance condition is satisfied in the first step, the token management contract of the blockchain system issues a proof-of-stake token to the user of the user system; and
the stake acquisition request signal includes information about an amount of a stake acquisition token and information about an amount of a proof-of-stake token to be acquired.

3. The method of claim 2, wherein step 1 is performed such that the token management contract of the blockchain system checks the condition of whether the amount of the stake acquisition token corresponds to the amount of the proof-of-stake token to be acquired according to an exchange ratio between the stake acquisition token and the proof-of-stake token based on the information about the amount of the stake acquisition token and the information about the amount of the proof-of-stake token included in the stake acquisition request signal.

4. The method of claim 3, wherein step 2 comprises:
step 2-1 in which the token management contract of the blockchain system transmits to a stake acquisition token contract a token transfer transaction that allows a stake acquisition token corresponding to the amount of the stake acquisition token to be transmitted to itself; and
step 2-2 in which the token management contract of the blockchain system changes proof-of-stake token information for the user of the user system by performing an increase of and storing information about an amount of the proof-of-stake token corresponding to the amount of the stake acquisition token transmitted to itself for the user of the user system.

5. The method of claim 1, wherein:
the distribution target token deposit step comprises:
step 1 in which a token management contract of the blockchain system receives the distribution target token transmission signal from a token distributor system;
step 2 in which the token management contract of the blockchain system transmits to the distribution target token contract a token transfer transaction that allows distribution target tokens corresponding to the amount of distribution target tokens to be transmitted to itself; and
step 3 in which the token management contract of the blockchain system updates information about an amount of distribution target tokens deposited so far, which is a cumulative amount of distribution target tokens deposited; and
the distribution target token transmission signal comprises information about an amount of distribution target tokens.

6. The method of claim 1, wherein the distribution target token withdrawal step comprises:
step 1 in which a token management contract of the blockchain system receives the distribution target token withdrawal request signal from the user system, and calculates an amount of distribution of distribution target tokens for the user of the user system based on this signal; and
step 2 in which the token management contract of the blockchain system transmits an amount of distribution target tokens corresponding to the calculated amount of distribution to the user of the user system.

7. The method of claim 6, wherein step 1 is performed such that the token management contract of the blockchain system calculates the amount of distribution by the formula “(a cumulative amount of distribution target tokens deposited so far−a cumulative amount of distribution target tokens deposited when the user withdrew distribution target tokens last)×a stake,” where the stake is “an amount of the proof-of-stake token owned by the user/a total amount of proof-of-stake tokens issued.”

8. The method of claim 6, further comprising, after step 1, a step in which the token management contract of the blockchain system performs compensation completion processing that updates “a cumulative amount of distribution target tokens deposited when the user withdrew distribution target tokens last” with “a cumulative amount of distribution target tokens deposited until the specific user transmits the distribution target token withdrawal request signal.”

9. The method of claim 6, wherein step 2 comprises a step in which the token management contract of the blockchain system transmits to a distribution target token contract a token transfer transaction that allows distribution target tokens corresponding to the amount of distribution to be transmitted to the user of the user system.

10. The method of claim 1, further comprising:
a step in which, when receiving a stake liquidation request signal from the user system, the token management contract of the blockchain system calculates an amount of return of a stake acquisition token for the corresponding user based on this signal;
a step in which the token management contract of the blockchain system changes the proof-of-stake token information according to the calculated amount of return; and
a step in which the token management contract of the blockchain system transmits to a stake acquisition token contract a stake acquisition token transfer transaction that that allows a stake acquisition token corresponding to the calculated amount of return to be transmitted to the user of the user system.

11. The method of claim 1, further comprising:
step 1 in which the token management contract of the blockchain system receives a stake transfer request signal including information about an amount of transfer and information about a transferee from the user system and calculates an amount of distribution of distribution target tokens for the user of the user system based on this signal;
step 2 in which the token management contract of the blockchain system transmits an amount of distribution target tokens corresponding to the calculated amount of distribution to the user of the user system; and
step 3 in which the token management contract of the blockchain system changes proof-of-stake token information by subtracting information about an amount of a proof-of-stake token corresponding to the information about the amount of transfer for the user of the user system and performing an increase of and storing information about an amount of the proof-of-stake token corresponding to the information about the amount of transfer for the transferee.

12. The method of claim 7, wherein, when the total amount of proof-of-stake tokens issued is changed, step 1 is performed such that the token management contract of the blockchain system calculates the amount of distribution by the formula “(current A−A when the user withdrew distribution target tokens last)×the amount of the proof-of-stake token currently owned,” where A is “the cumulative amount of distribution target tokens deposited so far/a total amount of proof-of-stake tokens issued at the time when the distribution target tokens are deposited.”

13. A device for stake-based token management on a blockchain system, the device being included in each of one or more nodes constituting the blockchain system and managing tokens based on stakes, the device comprising:
a proof-of-stake token acquisition management unit configured to issue a proof-of-stake token to a user of a user system based on a stake acquisition request signal for acquisition of a proof-of-stake token received from the user system;
a distribution target token deposit management unit configured to receive a distribution target token transmission signal for deposit of distribution target tokens from a token distributor system and updates a cumulative amount of distribution target tokens deposited based on the distribution target token transmission signal; and
a distribution target token withdrawal management unit configured to receive a distribution target token withdrawal request signal from the user system and transmits distribution target tokens to the user of the user system based on the received distribution target token withdrawal request signal.
